(19) United States
(12) Patent Application Publication
(10) Pub. No.: US 2016/0001503 A1
(43) Pub. Date: Jan. 7, 2016

(54) SYSTEM FOR 3D PROTOTYPING OF FLEXIBLE MATERIAL AND METHOD THEREOF

(71) Applicants: Inventec Appliances (Pudong) Corporation, Shanghai (CN); Inventec Appliances Corp., New Taipei City (TW); Inventec Appliances (Shanghai) Co., Ltd., Shanghai (CN)

(72) Inventors: Shih-Kuang TSAI, Taipei (TW); Li YU, Shanghai (CN)

(21) Appl. No.: 14/605,266

(22) Filed: Jan. 26, 2015

(30) Foreign Application Priority Data
Jul. 1, 2014 (CN) 201410310200.7

(51) Int. Cl. B29C 67/00; B29C 47/08

(52) U.S. Cl. CPC B29C 67/0055; B29C 47/0813; B33Y 10/00

(57) ABSTRACT

The present invention provides a system for 3D prototyping of flexible material and method thereof The system comprises: a loading machine for providing a polymer molten mass; a screw extruding machine for extruding the polymer molten mass; a metering pump for controlling the quantity of the polymer molten mass; an air compressor for compressing air; an air heater for heating the compressed air; a 3D modeling component for processing a 3D workpiece; the nozzle comprises a spinneret plate and a gas-flow hole, the spinneret plate is configured with a through hole for forming the extruded polymer molten mass into a polymer melt trickle, the gas-flow hole drafts the polymer melt trickle to a filiform polymer fiber to aggregate on the 3D workpiece; a solidifying component for solidifying the filiform polymer fiber to form the flexible material. The present invention can achieve convenient and quick printing for the flexible material.

### CROSS REFERENCE TO RELATED APPLICATION

This application claims priority to China Patent Document No. 201410310200.7, filed on Jul. 1, 2014 with the China Patent Office, which is incorporated by reference in its entirety.

### BACKGROUND OF THE INVENTION

1. Field of the invention

The present invention relates to a 3D prototyping technology, and more particularly, to a system for 3D prototyping of flexible material and the method thereof

2. Description of the prior art

3D printing is one of the 3D rapid prototyping technologies. It is a technology of making a three-dimensional object. The technology is based on a digital model file, which uses adhesive material, such as metal or plastic in powder shape, to create objects through printing layer by layer.

3D printing is usually operated by digital technology materials printer. In the past, 3D printing was used to manufacture model in the region of mold manufacture and industrial design. Nowadays, 3D printing is used to manufacture products directly. Some accessories are printing through this technology. Applications of 3D printing includes: jewelry, footwear, industrial design, architecture, construction (AEC), automotive, aerospace, dental and medical industries, education, geographic information systems, engineering, military, and many other fields.

The process of thermal spraying nonwoven is using high-speed thermal gas to draft the polymer molten mass extruded from the hole of the spinneret for forming superfine fiber and then spraying to the collection apparatus, and forming the adhesive-bonded fabric. The machine is the primary facility used for thermal spraying. The primary device is the spinneret using thermal gas to spray fiber mentioned above. A plurality of spinneret slits of the spinneret hole set on the spinneret for spraying the fiber.

However, nowadays, the process of thermal spraying nonwoven is usually processing fiber, which can not allow the materials to form the products directly; at the same time, the objects created by 3D printing are usually rigid. Therefore, a system for 3D prototyping of flexible material and method thereof are in need.

### SUMMARY OF THE INVENTION

The goal of the present invention is providing a system for 3D prototyping of flexible material and method thereof to print flexible material conveniently and rapidly.

To solve the problems mentioned above, the present invention provides a system for 3D prototyping of flexible material, comprising: a loading machine, a screw extruding machine, a metering pump, an air compressor, an air heater, a 3D modeling component, a nozzle, and a solidifying component. The loading machine is used for providing a polymer molten mass; the screw extruding machine is connected to the loading machine for extruding the polymer molten mass; the metering pump is connected to the screw extruding machine for controlling the quantity of the polymer molten mass extruded by the screw extruding machine; the air compressor is used for compressing air; the air heater is connected to the air compressor for heating the compressed air; the 3D modeling component is used for processing a 3D workpiece, wherein the 3D workpiece is used for supporting the flexible material; the nozzle, comprising a spinneret plate connected to the metering pump and a gas-flow hole connected to the air heater, wherein a through hole is configured on the spinneret plate for forming the extruded polymer molten mass into a polymer melt trickle, the gas-flow hole drafting the polymer melt trickle to form a filiform polymer fiber to aggregate on the 3D workpiece; and the solidifying component, connected to the 3D workpiece, for solidifying the filiform polymer fiber aggregated on the 3D workpiece to generate the flexible material.

According to another aspect of the present invention, the present invention provides a method for 3D prototyping of flexible material, which is applying the system for 3D prototyping of flexible material mentioned above, comprising the following steps of: controlling the quantity of a polymer molten mass extruded into a nozzle; utilizing a 3D modeling component to form a 3D workpiece; forming the extruded polymer molten mass into a polymer melt trickle with the nozzle; drafting the polymer melt trickle to form a filiform polymer fiber; aggregating the filiform polymer fiber onto the 3D workpiece; and solidifying the filiform polymer fiber to generate the flexible material.

Compare with the prior art, the present invention can achieve the goal of printing for the flexible material conveniently and quickly.

Additionally, the present invention combines the melt-blown process, from manufacturing fiber to forming the products, to achieve one-piece formation of the original melt-blown process, which is not only increasing the generating efficiency of the original process, but also achieving the manufacturing process with customization according to the parameters provided by the 3D model. Therefore, a product with accuracy scale can be manufactured.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1 is a structure diagram illustrating a system for 3D prototyping of flexible material of the present invention in an embodiment.

FIG. 2 is a schematic diagram illustrating a system for 3D prototyping of flexible material of the present invention in an embodiment.

FIG. 3 is a structure diagram illustrating a nozzle of the present invention in an embodiment.

FIG. 4 is a flow chart illustrating a system for 3D prototyping of flexible material of the present invention in an embodiment.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

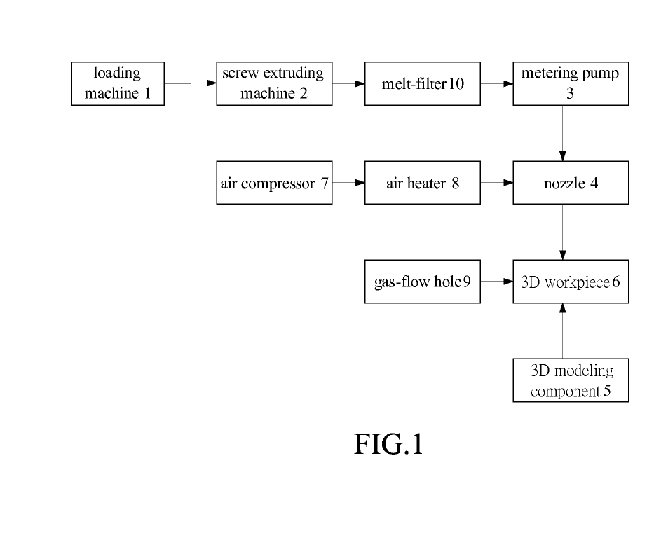

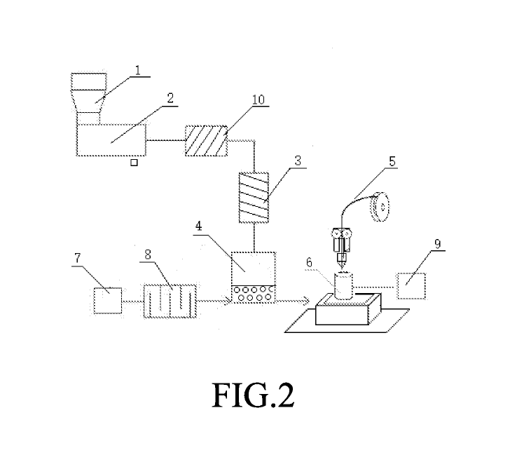

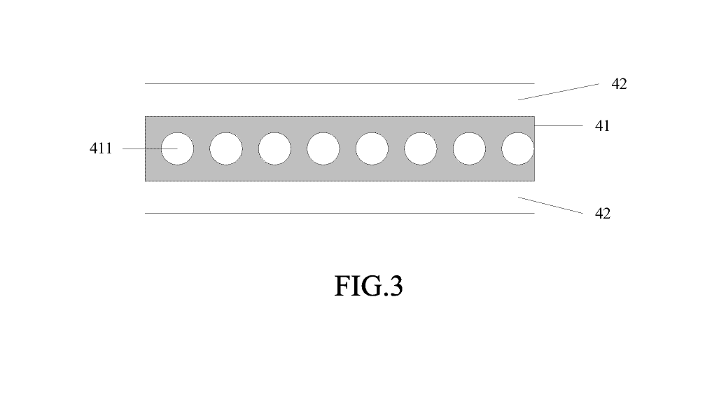

In first embodiment, please refer to FIG. 1 to FIG. 3. FIG. 1 is a structure diagram illustrating a system for 3D prototyping of flexible material of the present invention in an embodiment, FIG. 2 is a schematic diagram illustrating a system for 3D prototyping of flexible material of the present invention in an embodiment, and FIG. 3 is a structure diagram illustrating a nozzle of the present invention in an embodiment. The present invention provides a system for 3D prototyping of flexible material, comprising: a loading machine 1, a screw extruding machine 2, a metering pump 3, an air compressor 7, an air heater 8, a 3D modeling component 5, a nozzle 4, a solidifying component 9. The loading machine 1 is used for providing a polymer molten mass; the screw extruding machine 2 is connected to the loading machine 1 for extruding the polymer molten mass; the metering pump 3 is connected to the screw extruding machine 2 for controlling the quantity of the polymer molten mass extruded by the screw extruding machine; the air compressor 7 is used to compress air; the air heater 8 is connected to the air compressor 7 for heating the compressed air; the 3D modeling component 5 is used to process a 3D workpiece 6, wherein the 3D workpiece 6 is used for supporting the flexible material. In an embodiment, the 3D workpiece 6 is a receiving layer of the flexible material used for supporting the flexible material. The material used for forming the 3D workpiece 6 can be soluble material, such as Polyvinyl alcohol (PVA); the nozzle 4 comprises a spinneret plate 41 connected to the metering pump 3 and a gas-flow hole 42 connected to the air heater 8. A through hole 411 is configured on the spinneret plate 41 for forming the extruded polymer molten mass into a polymer melt trickle. The gas-flow hole 42 is used for drafting the polymer melt trickle to form a filiform polymer fiber to aggregating on the 3D workpiece 6; the solidifying component 9 is connected to the 3D workpiece 6 for solidifying the filiform polymer fiber aggregated on the 3D workpiece 6 to generate the flexible material. In an embodiment, through the interactive adhesion of the filiform polymer fiber, the cooled filiform polymer fiber finally is formed to be flexible material, such as nonwoven fabric. The generated flexible material can be the skin-tight cloth or outer package of products.

In an embodiment, the system for 3D prototyping of flexible material of the present invention further comprises a melt-filter 10, connected to the screw extruding machine 2 and metering pump 3, for filtering impurity from polymer molten mass.

In an embodiment, the solidifying component 9 performs solidifying the filiform polymer fiber can be applied with exhausting wind, UV-irradiation, laser sintering, or mist cooling.

In an embodiment, the 3D workpiece 6 is a 3D manikin. In practical application, the generated flexible material wraps the 3D manikin to manufacture high-precision synthetic clothes. The preset model can be utilized to construct the 3D manikin, and then construct the realistic 3D manikin through adjusting the measurements of the preset model or drawing a part of the preset model. Furthermore, constructing the 3D manikin also needs to consider factors of easily slipping off/on and the flexibility of the material.

In an embodiment, the 3D workpiece 6 is a flat plat for manufacturing clothes. In practical application, because the material which needs to be manufactured is flexible, the printing process can be performed as manufacturing a flatwise cloth on the flat plat to avoid complex supports for prototyping rapidly.

In an embodiment, the diameter of the through hole 411 is 0.0635 millimeter. In practical application, to spin the nanofiber, the diameter of the through hole 411 needs to be much smaller than the diameter of the hole of the spinneret plate of the conventional melt-blown machine. The diameter of the through hole 411 can be 0.0635 millimeter (63.5 micrometer) or 0.0025 inch (0.0025*2.54 cm=0.00635 cm). The total width of the combination of the spinneret plates 41 of the module structure can be longer than 3 meters. Therefore, the diameter of the filiform polymer fiber is about 500 nanometers, and the smallest diameter of the fiber can be 200 nanometers.

In an embodiment, the quantity of the spinneret plate 41 could be singular or plural. The spinneret plates 41 are combined according to a predetermined width when the quantity of the spinneret plate 41 is plural. The quantity of the through hole 411 configured on the spinneret plate 41 could be singular or plural. A three-row through hole 411 array is distributed on the spinneret plate 41, and the quantity of the through hole 411 in each row is 2,880. In practical application, since the through hole 411 of the spinneret plate 41 used for spinning the nanofiber is small, the productivity will decrease. Therefore, increase the quantity of the through hole 411 and the row of the through holes 411 on the spinneret plate 41 can avoid the decrease of the productivity. The present invention can combined a lot of the spinneret plates 41 (according to the width) to increase the productivity of spinning. In practical application, the quantity of the through hole 411 each row is 2880 per meter when the diameter of the through hole 411 is 63.5 micrometer. If three rows are applied, the total quantity of the through hole 411 is 8640, and the production is equal to the conventional melt-blown machine. Since the spinneret 41 with high-density through holes 411 is expensive and frangible (cleaved by high temperature under high pressure), an applicable technique for bonding the spinneret plate 41 with high-density through holes is applied to keep the spinneret plate 41 with high-density through holes 411 from disintegrating by high pressure.

In an embodiment, the flexible material is a flexible polyurethane material or a flexible rubber material.

The embodiment provides a system for 3D prototyping of flexible material and method thereof to print flexible material rapidly. Additionally, the embodiment combines the melt-blown process, from manufacturing fiber to forming the products, to achieve one-piece formation of original melt-blown process, which is not only increasing the generating efficiency of the original process, but also achieving the manufacturing process with customization according to the parameters provided by the 3D model. Therefore, a product with accuracy scale can be manufactured.

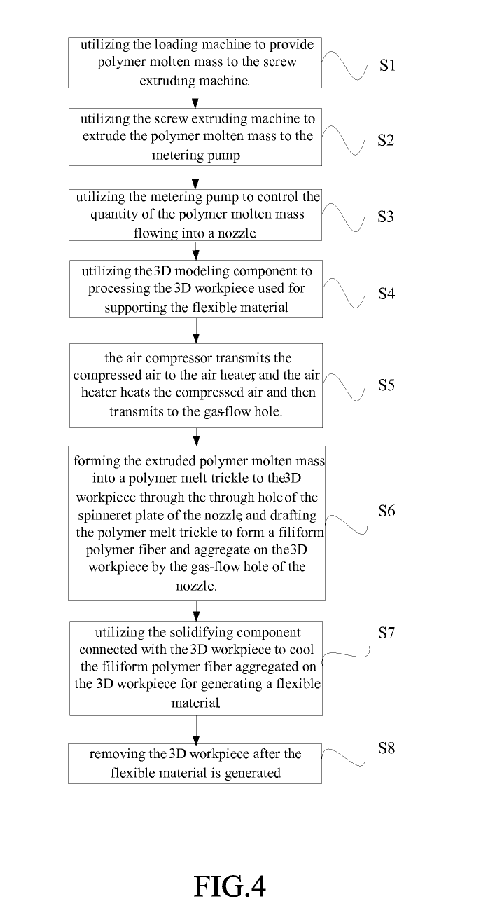

In the second embodiment, please refer to FIG. 4, the present invention further provides a method for 3D prototyping of flexible material. FIG. 4 is a flow chart illustrating a system for 3D prototyping of flexible material of the present invention in an embodiment, which applies the system for 3D prototyping of flexible material mentioned in the first embodiment. The method comprises the following steps of:

Step S1: utilizing the loading machine to provide polymer molten mass to the screw extruding machine.

Step S2: utilizing the screw extruding machine to extrude the polymer molten mass to the metering pump.

Step S3: utilizing the metering pump to control the quantity of the polymer molten mass flowing into a nozzle.

Step S4: utilizing the 3D modeling component to processing the 3D workpiece used for supporting the flexible material.

Step S5: the air compressor transmits the compressed air to the air heater, and the air heater heats the compressed air and then transmits to the gas-flow hole.

Step S6: forming the extruded polymer molten mass into a polymer melt trickle to the 3D workpiece through the through hole of the spinneret plate of the nozzle, and drafting the polymer melt trickle to form a filiform polymer fiber and aggregate on the 3D workpiece by the gas-flow hole of the nozzle.

Step S7: utilizing the solidifying component connected with the 3D workpiece to cool the filiform polymer fiber aggregated on the 3D workpiece for generating a flexible material.

Step S8: removing the 3D workpiece after the flexible material is generated.

Other details in practical application of the second embodiment can refer to the corresponding part in the first embodiment.

To summarize the statement mentioned above, the present invention can achieve the goal of printing the flexible material rapidly and conveniently. Furthermore, the present invention combines melt-blown process to achieve one-piece formation of the original melt-blown process, which is not only increasing the generating efficiency of the original process, but also achieving the manufacturing process with customization according to the parameters provided by the 3D model. Therefore, a product with accuracy scale can be manufactured.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A system for 3D prototyping of flexible material, comprising:
a loading machine, for providing a polymer molten mass;
a screw extruding machine, connected to the loading machine, for extruding the polymer molten mass;
a metering pump, connected to the screw extruding machine, for controlling the quantity of the polymer molten mass extruded by the screw extruding machine;
an air compressor, for compressing air;
an air heater, connected to the air compressor, for heating the compressed air;
a 3D modeling component, for processing a 3D workpiece, wherein the 3D workpiece is used for supporting the flexible material;
a nozzle, comprising a spinneret plate connected to the metering pump and a gas-flow hole connected to the air heater, wherein a through hole is configured on the spinneret plate for forming the extruded polymer molten mass into a polymer melt trickle, the gas-flow hole drafting the polymer melt trickle to form a filiform polymer fiber to aggregate on the 3D workpiece; and
a solidifying component, connected to the 3D workpiece, for solidifying the filiform polymer fiber aggregated on the 3D workpiece to generate the flexible material.

2. The system for 3D prototyping of flexible material of claim 1, further comprising:
a melt-filter, connected to the screw extruding machine and the metering pump, for filtering impurity from the polymer molten mass.

3. The system for 3D prototyping of flexible material of claim 1, wherein the solidifying process for the solidifying component to solidify the filiform polymer fiber can be applied with exhausting wind, UV-irradiation, laser sintering, or mist cooling.

4. The system for 3D prototyping of flexible material of claim 1, wherein the quantity of the spinneret plate is one or more.

5. The system for 3D prototyping of flexible material of claim 4, wherein the spinneret plates are combined according to a predetermined width when the quantity of the spinneret plate is a plurality.

6. The system for 3D prototyping of flexible material of claim 4, wherein the quantity of the through hole configured on the spinneret plate is one or more.

7. The system for 3D prototyping of flexible material of claim 6, wherein a three-row through hole array is distributed on the spinneret plate, and the quantity of the through hole in each row is 2,880.

8. The system for 3D prototyping of flexible material of claim 1, wherein the diameter of the through hole is 0.0635 millimeter.

9. The system for 3D prototyping of flexible material of claim 1, wherein the flexible material is a flexible polyurethane material or a flexible rubber material.

10. A method for 3D prototyping of flexible material, comprising the following steps:
controlling the quantity of a polymer molten mass extruded into a nozzle;
utilizing a 3D modeling component to form a 3D workpiece;
forming the extruded polymer molten mass into a polymer melt trickle with the nozzle;
drafting the polymer melt trickle to form a filiform polymer fiber;
aggregating the filiform polymer fiber onto the 3D workpiece; and
solidifying the filiform polymer fiber to generate the flexible material;

11. The method for 3D prototyping of flexible material of claim 10, further comprising the following step:
filtering impurity from the polymer molten mass through a melt-filter.

12. The method for 3D prototyping of flexible material of claim 10, in the step of forming the extruded polymer molten mass into a polymer melt trickle with the nozzle, wherein the polymer melt trickle is formed by a through hole configured on a spinneret plate of the nozzle

13. The method for 3D prototyping of flexible material of claim 10, in the step of drafting the polymer melt trickle to form a filiform polymer fiber, wherein the filiform polymer fiber is formed by a gas-flow hole configured on the nozzle.

14. The method for 3D prototyping of flexible material of claim 13, further comprising the following steps:
compressing air to an air heater for heating the air; and
exporting the heated air to the gas-flow hole configured on the nozzle.

15. The method for 3D prototyping of flexible material of claim 10, wherein the flexible material is a flexible polyurethane material or a flexible rubber material.
